(19) United States
(12) Patent Application Publication
(10) Pub. No.: US 2017/0147407 A1
(43) Pub. Date: May 25, 2017

(54) SYSTEM AND METHOD FOR PREDICITING RESOURCE BOTTLENECKS FOR AN INFORMATION TECHNOLOGY SYSTEM PROCESSING MIXED WORKLOADS

(71) Applicant: International Business Machines Corporation, Armonk, NY (US)

(72) Inventor: Samir A. Nasser, Durham, NC (US)

(21) Appl. No.: 14/950,179

(22) Filed: Nov. 24, 2015

(51) Int. Cl. G06F 9/50; G06F 9/52

(52) U.S. Cl. CPC G06F 9/5061; G06F 9/524

(57) ABSTRACT

A method of predicting resource bottlenecks for an information technology system processing mixed workloads includes determining, through a processor, a probability that one or more of a plurality of requests will access one of a plurality of resources, determining, through the processor, a performance metric of the one of the plurality of requests, identifying, through the processor, a potential hot spot based on the performance metric, calculating, through the processor, a probability that each of the plurality of requests will concurrently execute on the one of the plurality of resources, and providing, through the processor, an alert predicting that a bottleneck could occur at the one of the plurality of resources.

### BACKGROUND

The present invention relates to information technology systems and, more specifically, to a system and method for predicting resource bottlenecks for an information technology system processing mixed workloads.

Many information technology systems receive a high number of information requests. When multiple requests require the same resource, a slow or delayed response may result. Systems, such as middleware, may experience many concurrent requests for access to a resource. Typically, there are a number of request types being processed, each with its own need for specific resources. It is not unusual for such a system to experience bottlenecks as requests wait for access to a desired resource. Bottlenecks lead to undesirable delays in data processing that could result in user frustration.

### SUMMARY

According to an exemplary embodiment, a method of predicting resource bottlenecks for an information technology system processing mixed workloads includes determining, through a processor, a probability that one or more of a plurality of requests will access one of a plurality of resources, determining, through the processor, a performance metric of the one of the plurality of requests, identifying, through the processor, a potential hot spot based on the performance metric, calculating, through the processor, a probability that each of the plurality of requests will concurrently execute on the one of the plurality of resources, and providing, through the processor, an alert predicting that a bottleneck could occur at the one of the plurality of resources.

According to another aspect of an exemplary embodiment, a computer program product for predicting resource bottlenecks for an information technology system processing mixed workloads includes a computer readable storage medium having computer readable program code embodied therewith. The computer readable program code, when executed by a processor, causes the processor to: determine, through a processor, a probability that one or more of a plurality of requests will access one of a plurality of resources, determine, through the processor, a performance metric of the one of the plurality of requests, identify, through the processor, a potential hot spot based on the performance metric, calculate, through the processor, a probability that each of the plurality of requests will concurrently execute on the one of the plurality of resources, and provide, through the processor, an alert predicting that a bottleneck could occur at the one of the plurality of resources.

According to yet another aspect of an exemplary embodiment, a system includes a central processor unit (CPU), a non-volatile memory operatively connected to the CPU, and a bottleneck predicting module configured to predict resource bottlenecks. The bottleneck predicting module includes computer readable program code embodied therewith. The computer readable program code, when executed by the CPU, causes the CPU to: determine, through a processor, a probability that one or more of a plurality of requests will access one of a plurality of resources, determine, through the processor, a performance metric of the one of the plurality of requests, identify, through the processor, a potential hot spot based on the performance metric, calculate, through the processor, a probability that each of the plurality of requests will concurrently execute on the one of the plurality of resources, and provide, through the processor, an alert predicting that a bottleneck could occur at the one of the plurality of resources.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram depicting a system for predicting resource bottlenecks for an information technology system processing mixed workloads, in accordance with an exemplary embodiment;

FIG. 2 is a flow chart depicting a method of predicting resource bottlenecks for an information technology system processing mixed workloads, in accordance with an exemplary embodiment;

FIG. 3 is a table depicting request performance metrics for a plurality of resources, in accordance with an aspect of an exemplary embodiment;

FIG. 4 is a table depicting resource hot spots associated with a particular request, in accordance with an aspect of an exemplary embodiment; and

FIG. 5 is a table depicting resource hot spots associated with a particular request, in accordance with another aspect of an exemplary embodiment.

### DETAILED DESCRIPTION

Embodiments include systems, methods and computer program products for predicting resource bottlenecks for an information technology system that is processing a mixed workload. In one embodiment, a performance metric of a request and a probability that the request will access a resource are determined. Based on the performance metric a potential hot spot in the information technology system is identified. Next, a probability that one or more additional requests will concurrently execute on the same resource is calculated and an alert is generated predicting that a bottleneck may occur at the resources if the probability is greater than a threshold level.

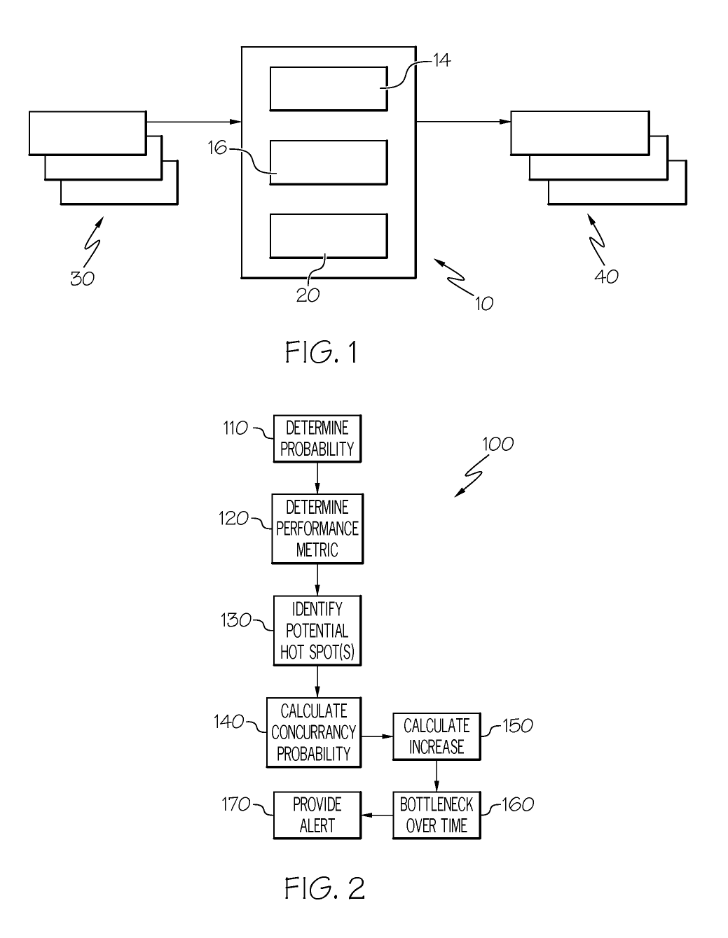

With reference now to FIG. 1, a system for predicting resource bottlenecks for an information technology system processing mixed workloads, in accordance with an exemplary embodiment, is indicated generally at 10. System 10 includes a central processor unit (CPU) 14 operatively connected to a non-volatile memory 16. System 10 also includes a bottleneck predicting module 20 which, as will be detailed more fully below, predicts the existence and location of resource bottlenecks or a reduction in processing throughput resulting from concurrently processing requests. Bottlenecks may exist at a physical resource, such as CPU 14, non-volatile memory 16, disks, networks and the like, or at a middleware resource level, such as a web container thread pool, database connection pool, and the like. Specifically, system 10 monitors each of a plurality of requests 30 seeking access to one or more of a plurality of resources. System 10 then predicts where bottlenecks may occur and provides an alert. A system administrator/operator may then have an opportunity to upgrade one or more of resources 40 before actual bottlenecks occur.

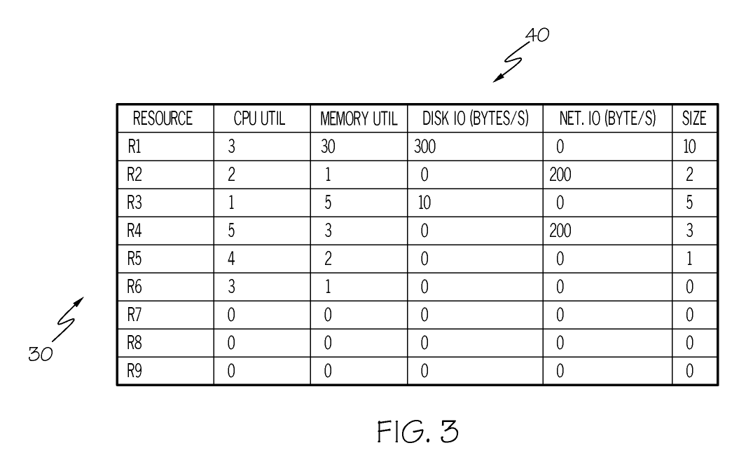

Reference will now follow to FIG. 2 in describing a method 100 of predicting resource bottlenecks for an information technology system processing mixed workloads, in accordance with an exemplary embodiment. In block 110, system 10 determines a probability that one or more of requests 30 will access one or more of resources 40. In exemplary embodiments, the requests 30 may take the form of one or more web container requests, shopping cart requests, Object Request Broker (ORB) requests, database requests and the like. System 10 divides a resource use time metric, such as shown in FIG. 3, by a total request measured response time to obtain a probability that one or more of requests 30 will access one or more of resources 40 For example, resource R1 of request 30 may request executing in, or use of, one of resources 40. In exemplary embodiments, the system 10 is configured to determine the probability for each of requests R1-R9 of requests 30 executing on each of resources 40.

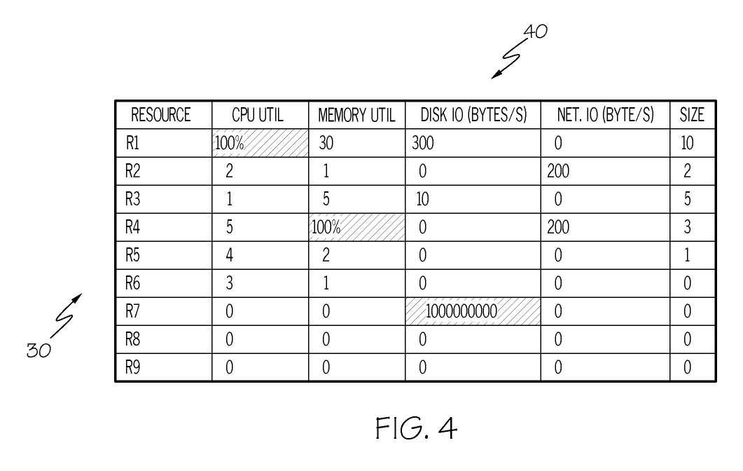

In block 120, a performance metric for each of requests R1-R9 of requests 30 are summed for each resource 40. For example, performance metrics for each of requests R1-R9 of requests 30 are summed for CPU utilization. In block 130, hot spot(s) are identified. For example, the performance metrics of R1-R9 of requests 30, are combined, for CPU utilization. In block 140, a probability of concurrency is determined. More specifically, system 10 calculates the probability that all requests 30 may execute or concurrently request CPU utilization. FIG. 4 depicts potential bottlenecks or hotspots for resources 40.

In further accordance with an aspect of an exemplary embodiment, system 10 determines an increase in concurrency of a particular one of requests 30 in block 150. For example, system 10 may determine a ratio of an increase of a particular request. System 10 may then multiply original performance metrics by the determined ratio to predict the likelihood of a bottleneck over time in block 160 and provide an alert to a system administrator/operator in block 170.

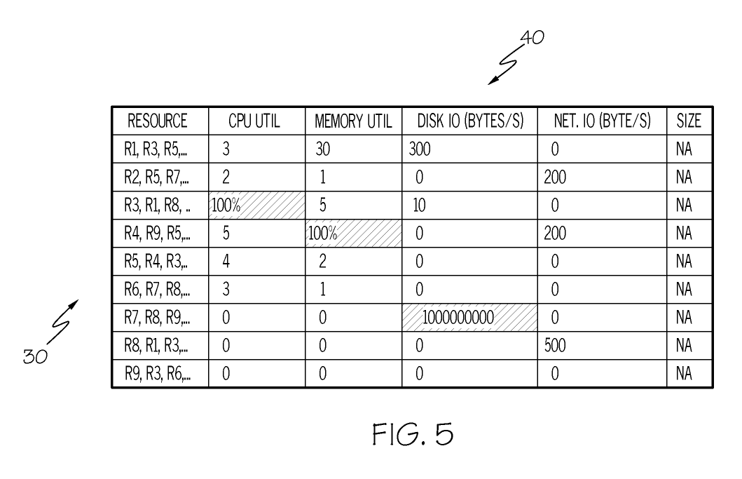

In accordance with another aspect of an exemplary embodiment, system 10 may determine performance metrics in block 120 by superimposing all request types, e.g., each of requests 30. For example, each web container request, shopping cart request, ORB request, database request and the like is superimposed. Request types may or may not superimpose on the same one of resources 40. Performance metrics are added for each superimposed request type and potential hotspots are identified such as shown in FIG. 5. Method 100 may then follow as described above.

In exemplary embodiments, each request may include a sequence of resources required to execute that request. For example, a shopping cart request may require access to each of multiple resources in a specific sequence. In one embodiment, such a sequence can be obtained using a tool such as ITCAM for Transaction Tracking.

At this point, it should be understood that the exemplary embodiments describe a system that predicts the likelihood that requests may create a bottleneck at one or more resources. Unlike current systems which measure or identify bottlenecks real time, the ability to predict the likelihood that a bottleneck may occur, in accordance with an exemplary embodiment, enables system administrators to plan for system upgrades. Thus instead of reacting to existing problems, the exemplary embodiments allows system administrators to proactively increase system capabilities to avoid bottlenecks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of predicting resource bottlenecks for an information technology system processing mixed workloads comprising:
determining, through a processor, a probability that one or more of a plurality of requests will access one of a plurality of resources;
determining, through the processor, a performance metric of the one of the plurality of requests;
identifying, through the processor, a potential hot spot based on the performance metric;
calculating, through the processor, a probability that each of the plurality of requests will concurrently execute on the one of the plurality of resources; and
providing, through the processor, an alert predicting that a bottleneck could occur at the one of the plurality of resources.

2. The method of claim 1, wherein calculating, through the processor, the probability that each of the plurality of requests will concurrently execute includes determining an increase of concurrency for the one of the plurality of resources.

3. The method of claim 2, further comprising: calculating a ratio of the increase of concurrency for the one of the plurality of resources.

4. The method of claim 3, wherein providing, through the processor, an alert predicting that a bottleneck could occur at the one of the plurality of resources includes multiplying a total performance metric of the one of the plurality of resources by the ratio of the increase of concurrency for the one of the plurality of resources.

5. The method of claim 1, wherein determining, through the processor, the performance metric of the one of the plurality of resources includes determining a total performance metric of each of the plurality of requests.

6. The method of claim 1, wherein determining, through the processor, a total performance metric includes calculating a maximum performance metric each of the plurality or requests.

7. The method of claim 6, further comprising: summing the maximum performance metric for each of the plurality of requests for a particular one of the plurality of resources.

8. A computer program product for predicting resource bottlenecks for an information technology system processing mixed workloads comprising a computer readable storage medium having computer readable program code embodied therewith, the computer readable program code, when executed by a processor, causing the processor to:
determine, through a processor, a probability that one or more of a plurality of requests will access one of a plurality of resources;
determine, through the processor, a performance metric of the one of the plurality of requests;
identify, through the processor, a potential hot spot based on the performance metric;
calculate, through the processor, a probability that each of the plurality of requests will concurrently execute on the one of the plurality of resources; and
provide, through the processor, an alert predicting that a bottleneck could occur at the one of the plurality of resources.

9. The computer program produce according to claim 8, wherein the computer readable program code, when executed by a processor, causes the processor to:
determine an increase of concurrency for the one of the plurality of resources.

10. The computer program product according to claim 9, wherein the computer readable program code, when executed by a processor, causes the processor to:
calculate a ratio of the increase of concurrency for the one of the plurality of resources.

11. The computer program product according to claim 10, wherein the computer readable program code, when executed by a processor, causes the processor to:
multiply a total performance metric of the one of the plurality of resources by the ratio of the increase of concurrency for the one of the plurality of resources

12. The computer program product according to claim 8, wherein the computer readable program code, when executed by a processor, causes the processor to:
determine a total performance metric of each of the plurality of requests.

13. The computer program product according to claim 8, wherein the computer readable program code, when executed by a processor, causing the processor to: calculate a maximum performance metric each of the plurality or requests.

14. The computer program product according to claim 13, wherein the computer readable program code, when executed by a processor, causes the processor to: sum the maximum performance metric for each of the plurality of requests for a particular one of the plurality of resources.

15. A system comprising:
a central processor unit (CPU);
a non-volatile memory operatively connected to the CPU; and
a bottleneck predicting module configured to predict resource bottlenecks, the bottleneck predicting module including computer readable program code embodied therewith, the computer readable program code, when executed by the CPU, causes the CPU to:
determine, through a processor, a probability that one or more of a plurality of requests will access one of a plurality of resources;
determine, through the processor, a performance metric of the one of the plurality of requests;
identify, through the processor, a potential hot spot based on the performance metric;
calculate, through the processor, a probability that each of the plurality of requests will concurrently execute on the one of the plurality of resources; and
provide, through the processor, an alert predicting that a bottleneck could occur at the one of the plurality of resources.

16. The system according to claim 15, wherein the computer readable program code, when executed by the CPU, causes the CPU to: determine an increase of concurrency for the one of the plurality of resources.

17. The system according to claim 16, wherein the computer readable program code, when executed by the CPU, causes the CPU to: calculate a ratio of the increase of concurrency for the one of the plurality of resources.

18. The system according to claim 17, wherein the computer readable program code, when executed by the CPU, causes the CPU to: multiply a total performance metric of the one of the plurality of resources by the ratio of the increase of concurrency for the one of the plurality of resources

19. The system according to claim 15, wherein the computer readable program code, when executed by the CPU, causes the CPU to: determine a total performance metric of each of the plurality of requests.

20. The system according to claim 15, wherein the computer readable program code, when executed by the CPU, causes the CPU to: calculate a maximum performance metric each of the plurality or requests, and, sum the maximum performance metric for each of the plurality of requests for a particular one of the plurality of resources.
